(19) United States
(12) Patent Application Publication
(10) Pub. No.: US 2013/0024320 A1
(43) Pub. Date: Jan. 24, 2013

(54) SYSTEM FOR MANAGING INTERACTION OF CUSTOMER WITH VENDOR

(71) Applicant: David BANINO, Netanya (IL)

(72) Inventor: David BANINO, Netanya (IL)

(21) Appl. No.: 13/186,457

(22) Filed: Jul. 19, 2011

(51) Int. Cl. G06Q 30/00; G06K 15/00

(52) U.S. Cl. 705/26.8; 235/383

(57) ABSTRACT

A method for facilitation of a transaction between a customer and at least one vendor by the intervention of a facilitator through a service program. To perform a transaction, the customer forms an interconnection with the service program using his/her handset or electronic device. Then a handshaking is accomplished between said customer and said facilitator, upon which accomplishment, the service program receives an indication as to the identity of a selected vendor. Then the service program receives an indication as to the nature of the selected product, and the service program looks after at least the monetary aspects of the transaction.

### FIELD OF THE INVENTION

The present invention relates to commercial transaction managing services and systems, according to which a service is provided over communications systems. More specifically the invention relates to purchasing, and management of commercial activities, by use of a mobile phone to collect information from a vendor and transferring the control of the interaction over to a third party service provider.

### BACKGROUND OF THE INVENTION

Modern day life takes as an expectation that automation will prevail whenever recurring instances of the same type take place. Whole procedures that used to be monitored or governed by personnel in the government offices or in private businesses, and services, are now often controlled or even executed by automated procedures. Typically, interaction with vendors such as shops or large storehouses is regarded as a significant activity in which recurring actions are performed. U.S. patent application 2009/0212112A1 describes a method that accomplishes reading of two dimensional barcodes by interpretation of a digital image. U.S. patent application 2011/0137742 discloses a method for managing the procedure of purchasing from a vendor, and especially the actual transfer of funds to the vendor.

### SUMMARY OF THE INVENTION

The method in accordance with the present inventions provides a facilitative element for shortening preparative steps in the accomplishment of a transaction between a vendor and a customer. A third party, the facilitator, is introduced. The facilitator services the interaction between the vendor and the customer. The facilitator acquires knowledge relating to the purchasing behavior of the prescribing customer and can represent the vendor on various occasions, including when the customer is not in the vendor's premises.

### BRIEF DESCRIPTION OF THE DRAWINGS

FIG. 1 illustrates the general setup of an embodiment in which the present invention is implemented;

FIGS. 2A-C illustrate in flowchart diagrams three alternative processes for accomplishing transactions in accordance with embodiments of the present invention;

FIG. 3A illustrates schematically several connections of the server in the context of embodiments of the invention;

FIG. 3B illustrates schematically several connections of the server in the context of embodiments of the invention in which a personal camera introduces data into the system.

### DESCRIPTION OF ILLUSTRATED EMBODIMENTS OF THE INVENTION

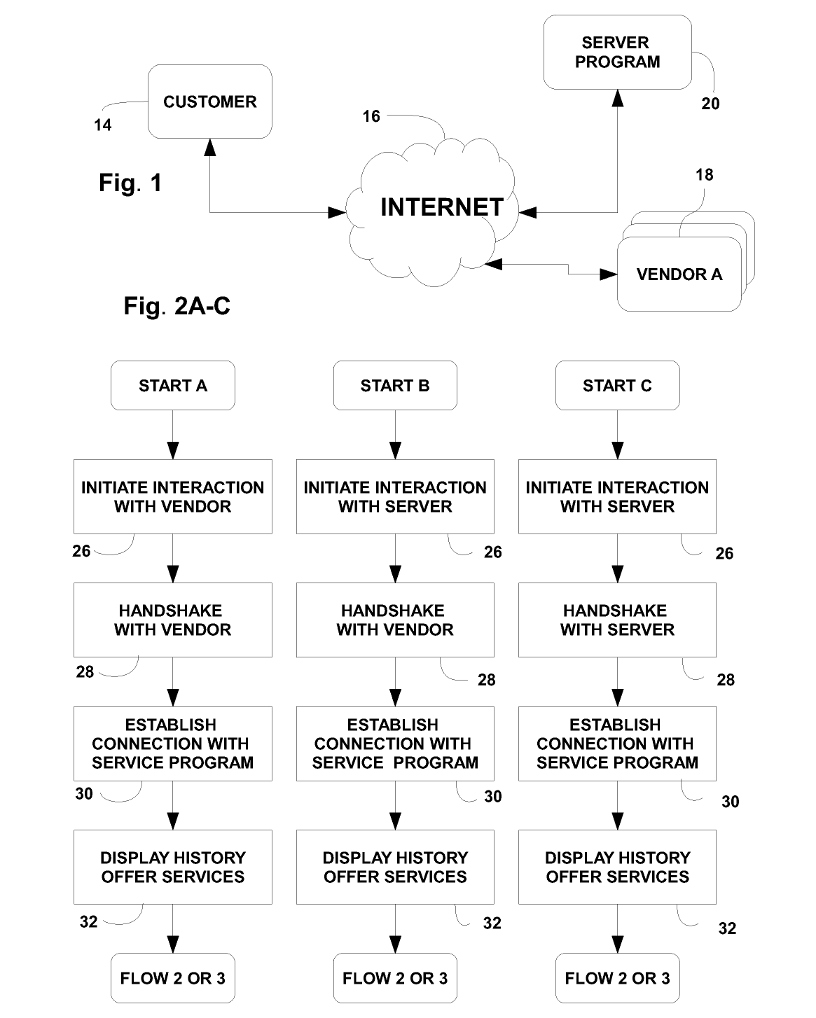

In accordance with the present invention a customer subscribes to a facilitating service that acts as a mediator between the customer and the vendor. This may require that the vendor also subscribe to the facilitating service. The facilitating service (referred to sometimes as the facilitator) supervises or oversees by means of programs associated with a server connected to the internet. In order to understand the entire structural framework in which the service of the invention is implemented, reference is made to FIG. 1. Customer/subscriber 14 connects to the internet 16, or indeed any available wide area network (WAN) in any place he/she may be, in or by the premises of a vendor/subscriber 18. Program 20 of the facilitator is associated with a service provided by a server reachable by the WAN. The facilitator manages the interaction between the customer and the vendor from this point on, as will be explained below. The facilitator typically has a plurality of vendors who have subscribed to the service. In FIGS. 2A-C, exemplary alternative ways of bringing about a transaction between the customer and the vendor are described schematically. In FIG. 2A, the customer in step 26 initiates an interaction with the vendor. This interaction may be, for example, reading (by an RFID reader) of an RFID response created by a transponder (tag) on the customer's handset while entering a storehouse. If the handset of the customer includes an appropriately coded RFID chip the vendor will recognise the approach of the customer. In step 28 the customer and the vendor perform handshaking. Once the handshaking is accomplished a connection of the customer with the service program on the service provider's server is achieved in step 30. Typically, the customer will then receive to his electronic device, for example a cellular hand set (smart phone) access to a report of his/her history of activities as related to the specific vendor. Offering services and or presenting goods or sales terms may follow. In this case, the customer has achieved the interaction with the facilitator's service program indirectly. In another embodiment of the invention, schematically illustrated in FIG. 2B, the customer initiates interaction directly with the server at step 26, for example by sending the server an SMS (short message) through the cellular services, in which the SMS has some significant information about his/her location, intended shopping plan, etc. At step 28 a handshaking session with the vendor is carried out, for example verifying the identity of the holder of the handset. At step 30 the service program is connected to the customer. Next, at step 32, details of recent activity of the customer as regards the specific vendor is sent to the customer for display. An assortment of services may be presented as well. In another embodiment of the invention, FIG. 2C, the customer initiates interaction with the service server at step 26, then continues to a handshaking procedure at step 28 with the server. Following, at step 30, the customer establishes a connection with the service program, and at step 32, details of recent activity of the customer as regards the specific vendor is sent to the customer for display, as well as suggested topics for the customer to consider.

In flow 2, illustrated at the bottom of FIGS. 2A-2C, the server program becomes receptive to purchasing orders by the customer, permitting (or not permitting) the purchasing of specific goods or services that are presented to the customer by the server program on his/her electronic device, for example a smartphone, and optionally also facilitating communications with a credit company or a bank. In flow 3 the server program only looks after the monetary aspects of the transaction, whereas the customer interacts with the vendor for selecting goods, questioning, verifying availability, etc. In the context of this disclosure the term “monetary aspects” relates to all or a part of the list as follows: verifying cash/credit availability, interacting with the customer's bank or credit company, sending invoices to the customer, notifying the vendor upon completion of the transaction. In other cases the service program may derive information relating to availability of a selected product, offer prices, and or suggest alternatives.

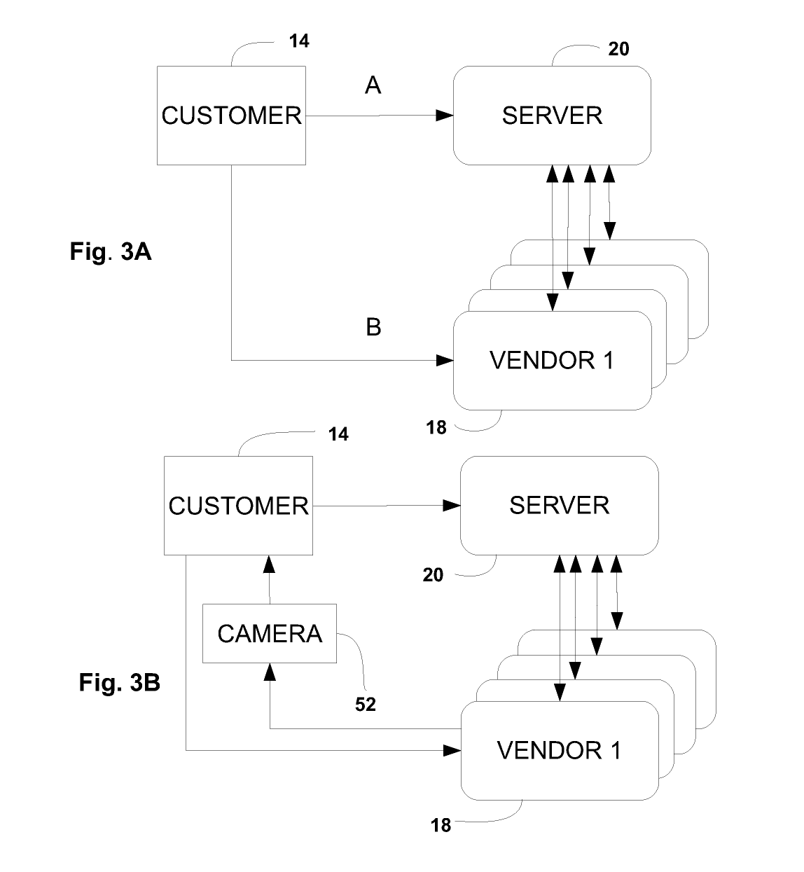

Referring to FIG. 3A, the customer 14 interacts first in option A with server program 20, (FIGS. 2B and 2C) in which case the customer 14 has to provide the server program an indication as to the identity of vendor 20 the customer has approached for business. Another possibility is that the customer 14 sends via option B a signal of presence to the vendor 18, and vendor 18 updates the server program 20 about customer's 14 active presence.

### Techniques for Interacting Between the Vendor and the Customer

As described above, an RFID tag associated with the customer, typically with his/her handset, if containing the right code, will be intercepted by an appropriate RFID reader of the vendor and used to automatically record the arrival/departure of a specific customer. Another possibility is an NFC (near field communications) system that can be activated passively or actively by a customer when entering the premises of a vendor. Typically, NFC systems are shorter in range of communications than a typical RFID, and are usually associated with intentional initiation of the interaction.

In another embodiment of the present invention, a structured ultrasonic/sonic signal is issued locally within the vendor's premises. A customer equipped with an appropriate microphone, typically in his/her hand-set, is able by the implementation of a suitable program, to decipher the code encoded within the ultrasonic/sonic signal and use it to extract information.

An example of connecting between the customer and server is described in FIG. 3B. The customer acquires an image of a barcode via his/her smartphone camera 52. By passing the information included within that barcode, the vendor's identity included, the server program receives from customer 14 all the information required to manage the transaction. Typically, in such a case, the information encoded in a barcode (one, two or three dimensional) contains not only an indication as to the identity of the vendor but also information about the identity of the product item considered or selected by the customer for purchasing. In this example there is no need for the actual physical presence of the customer in the premises of the vendor. When, for example, the customer receives an invoice or a bill from the vendor with a barcode, such as a QR code (quick response code), the identity of the vendor can be encoded in the code together with other essential information of the purchase, and the entire transaction can be handled by the server program. The visual code acquired by the camera can be processed in the customer's electronic device, for example the customer's hand-held phone, or it can be sent as an image for subsequent processing to the server program.

### Facilitator's Interactions

I. Facilitator—Vendor

In accordance with the present invention, a service provider may optionally offer a variety of services to the vendor. As inferred above, the vendor may require that the server program manages only the monetary issues of the transactions. In another option, the server program may also be delegated to interact with the customer with regards to non-monetary issues, for example offering services and goods, selling secondary items, advertising, and negotiating. As an option, the service provider may offer the vendor, as a part of their interaction, to issue barcodes for use by the vendor that will carry specific information elements such as the (already mentioned) identity of the vendor.

### II. Facilitator—Customer

As already referred to above, the customer, after handshaking with the server program, typically gets a report of the recent activities he/she performed using the server program as a vending activity manager. Additionally the customer may be entitled upon reaching an agreement with the service provider to additional services either for a fee, or for free, or both. As can be seen in FIGS. 3A-B, the service provider is typically contracted by a plurality of vendors, each of which may be entitled to a different set of services. As regards the plurality of customers connectable with the server program, a plurality of services can be provided to each as part of an agreed service parcel. However, it is to be understood that some services may be common, and some are not. For example, the customer receives a program that facilitates deciphering (decoding) the information encoded within the barcode.

Departmental Interaction with a Customer

In another aspect of the present invention, a customer, roaming inside the premises of a vendor such as a large shop or warehouse, is able to contact specific departments within the shop and interact with them either directly or via the server program on the internet. To implement such a task the departments in a large shop may be equipped with a short range communications system, such as an RFID, WIFI access point or an audio, ultrasonic/sonic source of structured sound. The communications system therefore need not necessarily be a full duplex system since the customer may communicate with the vendor or a department thereof via a server of the service provider. However, the departmental approach allows for specific information regarding goods of a specific nature to be conveyed to a roaming customer, including announcement regarding offers or deals etc. It is appropriate for a customer who is interested in a specific item, or family of items, to be informed about when he/she reaches the specific department in which a short range communications system is installed. The interaction of the customer with the different departments can be recorded and analyzed by the server service program and then analyzed in a methodology referred to as data mining In such methodology the habits and needs of each customer regarding purchasing of goods can be analyzed based on the data-base of his/her activities, and the appeal of the vendor to the customer may be made more effective as a result.

### Duration—Related—Payments

This aspect of the invention relates to a vendor that collects information about the customer, such as by acquiring images of the customer's indicia, typically vehicle number. Another option for acquiring indicia of a customer is by receiving a response of a transponder of a customer, such as by an RFID reader sensing an RFID tag associated with the customer's handset. The vendor or the customer can connect to the service over the internet and then time measurement can begin. When the customer vacates the premises of the vendor, such as a parking lot, a final reading is made electronically or by acquiring an image of the indicia of the customer. The service program receives the data and then calculates the time of stay, and sends an invoice based on the hourly fee, to the customer's handset.

### Handshaking

The nature and conditions of service provided to a customer are either negotiated or agreed upon by the customer as a preparative step before contracting the facilitator. The agreement defines the terms and scope of service provided to the customer. Before each new transaction is accomplished, a session referred to as handshaking in the present disclosure, takes place. Handshaking relates to a variety of connection facilitating activities carried out complying with the conditions and terms set out as explained above. Typically such a session includes A. verifying the identity of the customer trying to interact with the server program, B. verifying the availability of funds in the customer's account, C. reporting to the customer about his last interactions with the vendor.

1. A method for facilitation of a transaction between a customer and at least one vendor by the intervention of a facilitator through a service program, said method comprising the steps:
said customer interconnecting with said service program, using his/her handset;
accomplishing handshaking between said customer and said facilitator, further to which the service program receives an indication as to the identity of a selected vendor;
sending to said service program information about the identity of a selected product; and
said service program looking after at least the monetary aspects of said transaction.

2. A method for facilitation of a transaction as in claim 1 wherein said indication is encoded in a barcode of said selected vendor.

3. A method for facilitation of a transaction as in claim 1, wherein said forming of said interconnecting with said service program is direct.

4. A method as in claim 3 wherein said indication of said selected vendor is encoded in a barcode at the premises of said selected vendor, and wherein barcode is acquired by a camera of said customer to be subsequently decoded.

5. A method as in claim 4 wherein said barcode is a QR barcode.

6. A method for facilitation of a transaction as in claim 1, wherein said forming of said interconnection with said service program is indirect, whereby said customer initiates a connection with said selected vendor first.

7. A method as in claim 4 wherein said initiation of connection with said selected vendor employs an RFID reader of said vendor.

8. A method as in claim 4 wherein said initiation of connection with said selected vendor employs a NFC reader of said vendor.

9. A method as in claim 4 wherein said initiation of connection with said selected vendor employs a camera of said vendor that identifies a plate number of said customer by decoding an image of said number.

10. A method as in claim 4 wherein said initiation of connection with said vendor employs a microphone of said customer identifying structures of an audio transmission of said vendor at least in one site on said vendor's premises.
